(19) United States
(12) Patent Application Publication
(10) Pub. No.: US 2005/0269166 A1
(43) Pub. Date: Dec. 8, 2005

(54) Adjustable disk brake assembly for a bicycle

(76) Inventor: Jui-Pin Chen, Changhua City (TW)

Correspondence Address: Dennison, Schultz & Dougherty & MacDonald, Suite 105, 1727 King Street, Alexandria, VA, 22314, US

(21) Appl. No.: 10/862,326

(22) Filed: Jun. 8, 2004

(51) Int. Cl. B60L 7/00; B62L 5/00

(52) U.S. Cl. 188/26

(57) ABSTRACT

An adjustable disk brake assembly for a bicycle includes a disk brake, an inner adjusting strip, a mounting socket and a tightening bolt. The disk brake includes a brake body. The inner adjusting strip is slidably mounted on the brake body and has an exterior adjusting convex surface. The mounting socket holds the inner adjusting strip and includes an outer clamp. The outer clamp is adjustably mounted around the inner adjusting strip and has two ends and an interior adjusting concave surface abutting slidably on the exterior adjusting convex surface on the inner adjusting strip. The tightening bolt is mounted on the ends of the outer clamp to narrow the outer clamp. Consequently, the disk brake assembly provides not only linear alignment but also angular alignment relative to a braking disk to efficiently arrest the braking disk and is easy to be assembled and operated.

### BACKGROUND OF THE INVENTION

1. Field of the Invention

The present invention relates to a disk brake assembly for a bicycle, and more particularly to an adjustable disk brake assembly that provides not only linear adjustment but also angular adjustment for aligning precisely a brake body with a braking disk on the bicycle.

2. Description of Related Art

With reference to FIG. 4, a conventional disk brake assembly for a bicycle is attached to a fork (60) of the bicycle to press two frictional braking pads against the sides of a braking disk (70) to stop the bicycle in motion. The fork (60) has two mounting ears (61) to mount the disk brake assembly.

The disk brake assembly comprises a U-shaped mounting socket (62), a brake body (63) and multiple fasteners such as bolts (64). The mounting socket (62) is attached to the mounting ears (61) on the fork (60) and has two end blocks (621). Each of the end blocks (621) has an elongated hole (622), and the elongated holes (622) are aligned with each other.

The brake body (63) is adjustably mounted between the end blocks (621) by means of the bolts (64) and has a braking slot (631) to receive a segment of the braking disk (70). The frictional braking pads are respectively mounted in the braking slot (631) at the sides of the braking disk (70) and will be pressed against the braking disk (70) to stop the braking disk (70) in rotation.

The bolts (64) are respectively extended into the elongated holes (622) and screw into the brake body (63). The frictional braking pads need to be respectively arranged with the sides of the braking disk (70) so that the braking pads efficiently arrest the braking disk (70). Therefore, an exact alignment between the braking pads in the braking slot (631) and the braking disk (70) is needed and is implemented by adjusting the brake body (63) along the elongated holes (622). The elongated holes (622) will provide a slight straight adjustment for aligning the braking pads with the braking disk (70).

However, the slight straight adjustment of the brake body (63) is restricted by the lengths of the elongated holes (622), which cannot provide a desirable adjustment for the braking pads in the brake body (63) relative to the braking disk (70). In addition, adjusting angular positions of the brake body (63) relative to the braking disk (70) is not easy and inconvenient to achieve.

With reference to FIGS. 5 and 6, another type of conventional disk brake assembly is attached to the mounting ears (61) on the fork (60) and comprises a U-shaped mounting socket (71), a brake body (72), two angle adjustment devices (73) and multiple fasteners (74).

The mounting socket (71) is attached to the mounting ears (61) and has two ends (712). The brake body (72) is mounted at the ends (712) of the mounting socket (71) and comprises two mounting feet (722). Each of the mounting feet (722) has an elongated hole (723). The elongated holes (723) are respectively aligned with the ends (712) of the mounting socket (71).

The angle adjustment devices (73) are respectively mounted on the mounting feet (722) of the brake body (71), and each of them comprises a hollow conic base (731) and an adjusting ring (732). The conic base (731) is mounted on the mounting foot (722) and has a tapered convex surface (733). The adjusting ring (732) is rotatably mounted on the convex surface (733) of the conic base (731) and has an inner concave surface (734). The concave surfaces (734) abut slidably on the convex surfaces (733) to permit angle adjustments for the brake body (72) relative to the braking disk (70) being available.

The fasteners (74) such as bolts extend respectively into the angle adjustment devices (73) and the elongated holes (723) and screw respectively into the ends (712) of the mounting socket (71) while the angle adjustments of the brake body (72) are being completed.

Therefore, a person can adjust not only the linear positions but also the angular positions of the brake body (72) relative to the braking disk (70) through the elongated holes (723) and the angle adjustment devices (73) to obtain a great braking effect. However, the latter conventional disk brake assembly comprises too many parts, which raises manufacturing costs and causes assembling the disk brake assembly on the fork (60) to be difficult.

To overcome the shortcomings, the present invention provides an improved adjustable disk brake assembly for a bicycle to mitigate or obviate the aforementioned problems.

### SUMMARY OF THE INVENTION

The main objective of the invention is to provide a simple and adjustable disk brake assembly for a bicycle, and the disk brake assembly can be adjusted its both linear positions and angular positions relative to a braking disk of the bicycle to get efficient braking effects.

An adjustable disk brake assembly for a bicycle in accordance with the present invention includes a disk brake, an inner adjusting strip, a mounting socket and a tightening bolt. The disk brake includes a brake body having an exterior surface and a braking slot for receiving a segment of a braking disk. The inner adjusting strip is slidably mounted on the exterior surface of the brake body and has an exterior adjusting convex surface. The mounting socket holds the inner adjusting strip and includes an outer clamp and multiple mounting feet. The outer clamp is adjustably mounted around the inner adjusting strip and has an exterior surface, an interior adjusting concave surface abutting slidably on the exterior adjusting convex surface on the inner adjusting strip, a first end and a second end aligned with the first end. A gap with a width is formed between the first and the second ends. The mounting feet are formed on the exterior surface of the outer clamp. The tightening bolt is mounted on the first and the second ends to change the width of the gap. Consequently, the disk brake assembly has a simple configuration, includes fewer components than prior art ones and provides not only linear alignment but also angular alignment for positioning the braking slot relative to the braking disk to efficiently arrest the braking disk. The disk brake assembly is easy to be fabricated, assembled and operated.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of an adjustable disk brake assembly in accordance with the present invention;

FIG. 2 is an operational elevational view of the adjustable disk brake assembly in FIG. 1 when the adjustable disk brake assembly is mounted on a fork;

FIG. 3 is an operational elevational view in partial section of the adjustable disk brake assembly in FIG. 2;

FIG. 4 is a perspective view of a conventional disk brake assembly in accordance with the prior art;

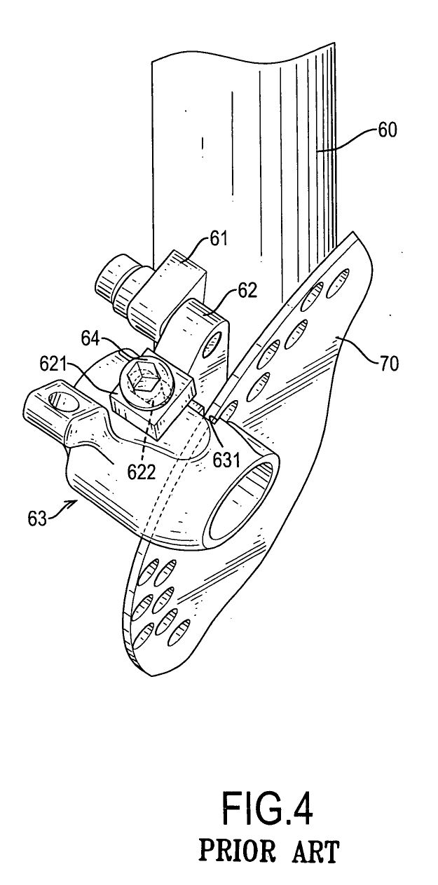

FIG. 5 is an exploded perspective view of another type of conventional disk brake assembly in accordance with the prior art; and

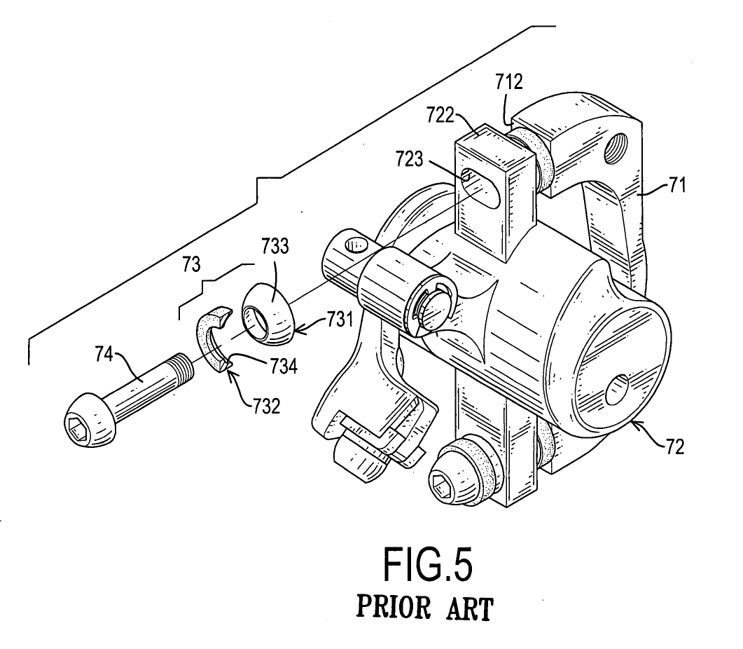

FIG. 6 is an operational elevational view of the conventional disk brake assembly in FIG. 5 when the conventional disk brake assembly is mounted on a fork.

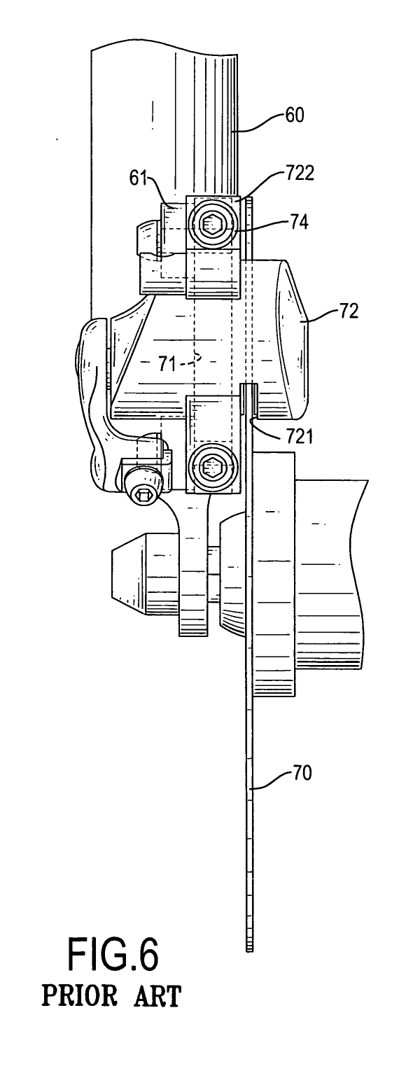

### DETAILED DESCRIPTION OF PREFERRED EMBODIMENT

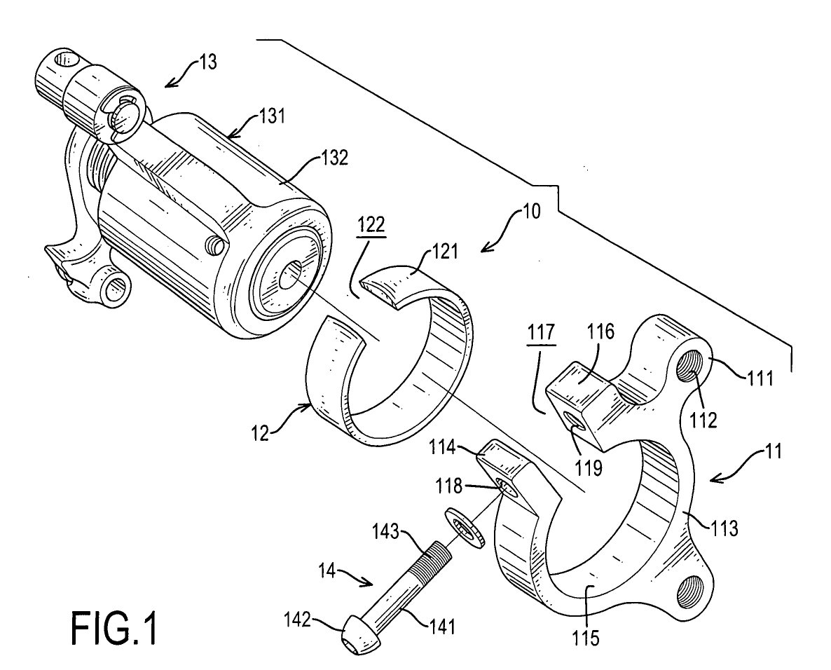

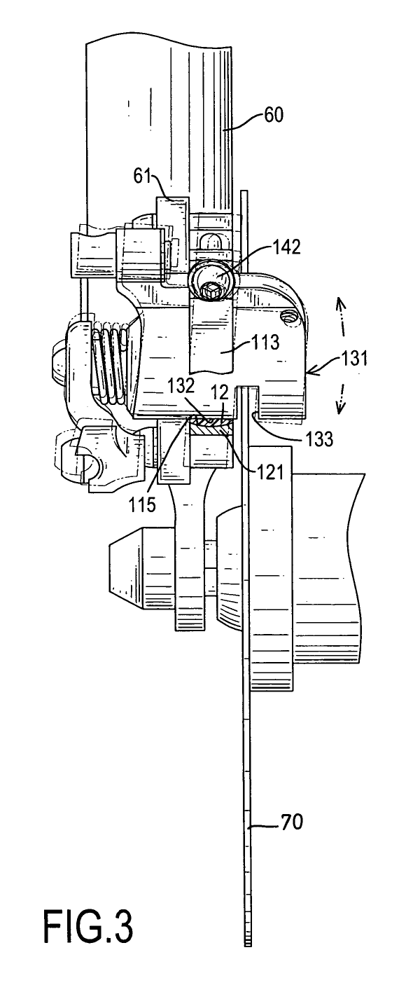

With reference to FIGS. 1 and 3, an adjustable disk brake assembly (10) for a bicycle in accordance with the present invention is mounted on a fork (60) to brake a rotatable braking disk (70) and comprises a mounting socket (11), an inner adjusting strip (12), a disk brake (13) and a tightening bolt (14). The fork (60) has two mounting ears (61) on which the disk brake assembly (10) is mounted.

The mounting socket (11) is attached to the mounting ears (61) on the fork (60) and comprises two mounting feet (111) and an outer clamp (113). The outer clamp (113) is a C-shaped or the like clamp and has an exterior surface, an interior adjusting surface (115), a first end (114) and a second end (116). The mounting feet (111) are integrally formed on the exterior surface of the outer clamp (113) and are respectively aligned with the mounting ears (61) on the fork (60). Each of the mounting feet (111) has a threaded hole (112) to attach the entire mounting socket (11) to the mounting ears (61).

The interior adjusting surface (115) is a concave surface. The first end (114) is aligned with the second end (116) and has a through hole (118). The second end (116) has a threaded hole (119) aligned with the through hole (118) in the first end (114). A gap (117) with a width is formed between the first and the second ends (114, 116) to allow narrowing or broadening an area embraced by the outer clamp (113).

The inner adjusting strip (12) is mounted on the disk brake (13) and is held by the outer clamp (113). The inner adjusting strip (12) is C-shaped and has an exterior adjusting surface (121) and two opposite ends with a gap (122) between the two opposite ends. The exterior adjusting surface (121) of the inner adjusting strip (12) is a convex surface and abuts slidably against the concave interior adjusting surface (115) of the outer clamp (113).

The disk brake (13) comprises a brake body (131) on which the inner adjusting strip (12) is adjustably mounted. The brake body (131) may have a cylindrical or an elliptic shape and has an exterior surface (132) and a braking slot (133). The inner adjusting strip (12) is slidably mounted on the exterior surface (132) of the brake body (131). The braking slot (133) receives a segment of the braking disk (70) and two frictional braking pads alongside the braking disk (70).

The fastening bolt (14) comprises a shank (141) and an enlarged head (142). The shank (141) has two opposite ends and an exterior thread (143). The enlarged head (142) and the exterior thread (143) are respectively formed at the opposite ends of the shank (141). The exterior thread (143) extends through the through hole (118) in the first end (114) of the outer clamp (113) and screws into the threaded hole (119) in the second end (116) to narrow the width of the gap (117) as the tightening bolt (14) is tightened. The width reduction of the gap (117) will render the outer clamp (113) to firmly hold the inner adjusting strip (12) on the exterior surface (132) of the brake body (131) in position.

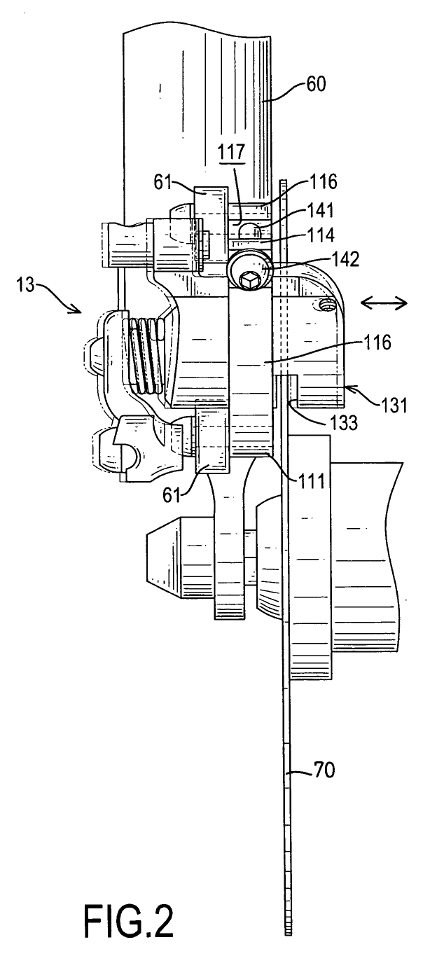

With further reference to FIGS. 2 and 3, adjusting the disk brake assembly (10) in accordance with the present invention is convenient. Loosening the tightening bolt (14) will permit the inner adjusting strip (12) to be able to move on the exterior surface (132) of the brake body (131) to acquire a desired linear position. Meanwhile, the brake body (131) is able to adjust its angular position relative to the fork (60) through the fitting between the convex exterior adjusting surface (121) of the inner adjusting strip (12) and the concave interior adjusting surface (115) of the outer clamp (113) to align the braking pads in the braking slot (133) with the braking disk (70). Tightening the tightening bolt (14) to narrow the gap (117) will lock the inner adjusting strip (12) on the brake body (131) when the alignment between the braking slot (133) and the braking disk (70) is completed.

Consequently, the disk brake assembly (10) in accordance with the present invention has a simple configuration, comprises fewer components than the prior art one and provides not only linear alignment but also angular alignment for positioning the braking slot (133) relative to the braking disk (70) to efficiently arrest the braking disk (70). The disk brake assembly (10) is easy to be fabricated, assembled and operated.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the scope of the appended claims.

1. An adjustable disk brake assembly for a bicycle, and the adjustable disk brake assembly comprising
a disk brake comprising a brake body having an exterior surface and a braking slot for receiving a segment of a braking disk;
an inner adjusting strip being C-shaped, slidably mounted on the exterior surface of the brake body and having an exterior adjusting surface, two opposite ends and a gap formed between the opposite ends;
a mounting socket mounted on the inner adjusting strip on the exterior surface of the brake body and comprising
an outer clamp adjustably mounted around the inner adjusting strip and having
an exterior surface;
an interior adjusting surface abutting slidably on the exterior adjusting surface on the inner adjusting strip;
a first end having a through hole;
a second end aligned with the first end and having a threaded hole aligned with the through hole; and
a gap with a width formed between the first and the second ends; and
multiple mounting feet formed on the exterior surface of the outer clamp; and
a tightening bolt mounted on the first and the second ends to change the width of the gap and having
a shank with two opposite ends and an exterior thread; and
an enlarged head, wherein the enlarged head and the exterior thread are respectively formed at the opposite ends of the shank, and the end with the exterior thread of the shank extends into the through hole in the first end and screws into the threaded hole in the second end of the outer clamp.

2. (canceled)

3. The adjustable disk brake assembly for a bicycle as claimed in claim 1, wherein the exterior adjusting surface of the inner adjusting strip is a convex surface, and the interior adjusting surface of the outer clamp is a concave surface.

4. (canceled)

5. The adjustable disk brake assembly for a bicycle as claimed in claim 1, wherein the disk body of the disk brake is cylindrical.

6. The adjustable disk brake assembly for a bicycle as claimed in claim 1, wherein the outer clamp is C-shaped.
